(19) United States
(12) Patent Application Publication
(10) Pub. No.: US 2013/0160356 A1
(43) Pub. Date: Jun. 27, 2013

(54) FUNGUS CULTIVATION DEVICE

(71) Applicant: Chun-Che Hsieh, HsinChu (TW)

(72) Inventor: Chun-Che Hsieh, HsinChu (TW)

(21) Appl. No.: 13/537,724

(22) Filed: Jun. 29, 2012

(30) Foreign Application Priority Data
Dec. 22, 2011 (TW) 100224246

(51) Int. Cl. A01G 1/04

(52) U.S. Cl. 47/1.1

(57) ABSTRACT

A fungus cultivation device includes at least one accommodating structure and a light-emitting diode module. The accommodating structure is disposed with a main body having an opening. The main body is internally disposed with an accommodating space for accommodating fungi strains and a light-permeable cover for covering the opening so as to seal the accommodating space. A plurality of light-emitting diodes of the light-emitting diode module irradiate the accommodating structure to supply a light source for the fungus inside the accommodating structure, thereby facilitating fungus growth.

### BACKGROUND OF THE INVENTION

1. Field of the Invention

The present invention relates to a fungus cultivation device, in particular to a fungus cultivation device for facilitating fungus growth by using light-emitting diodes as light sources.

2. Description of the Related Art

Presently, common mushroom cultivation manners are mostly cultured by manual manners in large cultivation facilities. In the cultivation process, the control of temperature, humidity and ventilation conditions has a decisive effect on the shape and quality of mushrooms. Cultivation manners can be roughly divided into plastic bag cultivation (such as Shiitake mushroom, agaric and abalone mushroom), bottling cultivation (such as golden needle mushroom, agaric and agrocybe aegerita), earth cultivation (such as agaricus mushroom), bed-log cultivation (such as shiitake mushroom and agaric) and the like. Wooden meal is mainly taken as substrate in the two former manners, straws and soil are taken as a nutritional substrate in the third manner and cut-off logs are taken as a cultivation substrate for the last manner.

Since mushrooms must grow in a dark and damp environment in general, ultraviolet light generated by sunlight and incandescent light or infrared rays at higher temperature would block mushroom growth. Consequently, mushroom growth cannot be effectively facilitated by directly using traditional light sources.

### SUMMARY OF THE INVENTION

In view of the aforementioned drawbacks, it is a primary objective of the present invention to provide the fungus cultivation device for facilitating fungus growth by utilizing light-emitting diodes as light sources.

To achieve the aforementioned objective, the present invention provides a fungus cultivation device comprising: at least one accommodating structure and a light-emitting diode module, wherein the accommodating structure is provided with a main body having an opening, and an accommodating space is formed in the main body to accommodate to accommodate fungi strains, and a light-permeable cover covers the opening so as to seal the accommodating space, and when a plurality of light-emitting diodes of the light-emitting diode module irradiate the accommodating structure, the light-emitting diodes can serve as light sources for fungi in the accommodating structure to facilitate fungus growth.

### BRIEF DESCRIPTION OF THE DRAWINGS

FIG. 1 is an exploded view of the structure of an accommodating structure of the present invention;

FIG. 2 is an appearance stereogram of the fungus cultivation device in accordance with the first embodiment of the present invention;

FIG. 3 is a schematic view of the usage configuration of the fungus cultivation device of the present invention; and

FIG. 4 is an appearance stereogram of the fungus cultivation device in accordance with the second embodiment of the present invention.

### DESCRIPTION OF THE PREFERRED EMBODIMENTS

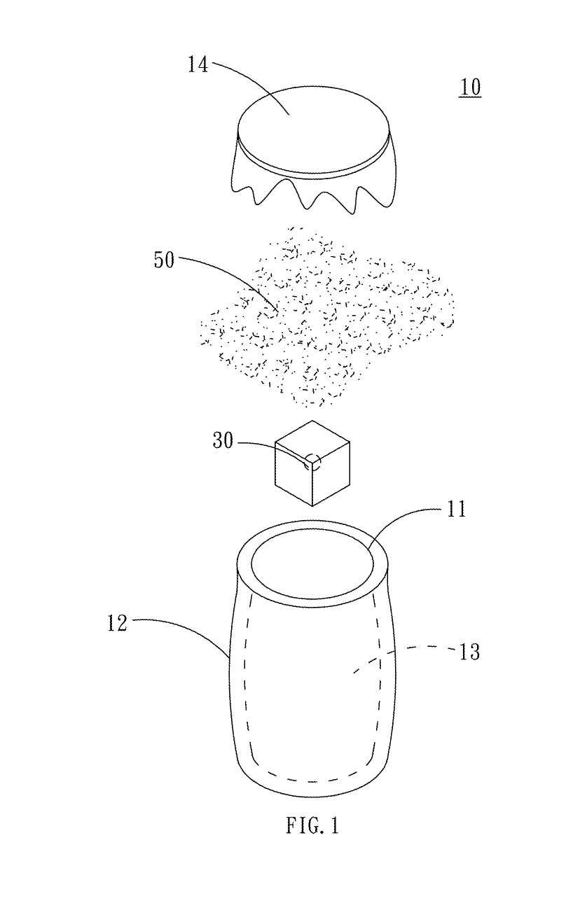

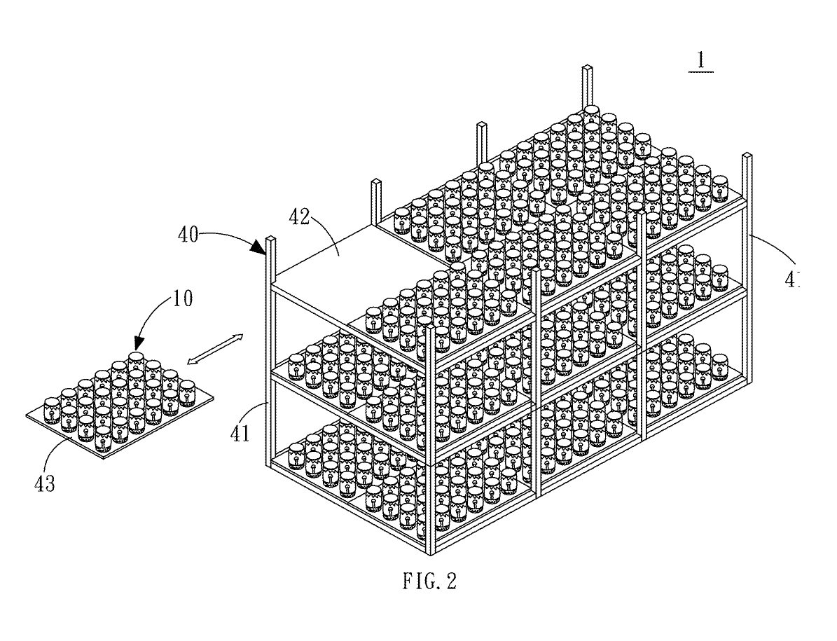

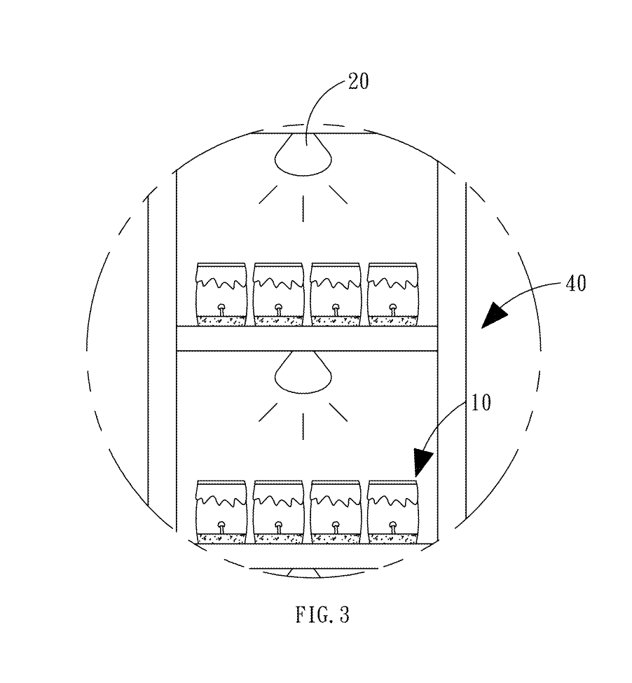

With reference to FIGS. 1 to 3, the present invention provides a fungus cultivation device (1) comprising: at least one accommodating structure (10) and a light-emitting diode module (20); wherein:

The accommodating structure (10) is provided with a main body (12) having an opening (11). In the embodiments as shown in figures, the main body can be a bottle, such as a plastic bottle or a glass bottle. The main body (12) is internally provided with an accommodating space (13) to accommodate fungi strains (30), and a light-permeable cover (14) covers the opening (11) so as to seal the accommodating space (13); certainly, the main body can also be a bag.

The light-emitting diode module (20) is provided with a circuit board and a plurality of light-emitting diodes (not shown in the figure) arranged on the circuit board. Each light-emitting diode irradiates the accommodating structure (10), the light-emitting diode module (20) is further provided with a power supply member (not shown in the figure), and the power supply member is connected to the circuit board and can be connected to supply mains via an electric wire, or directly take a battery or a rechargeable battery as a power source.

While in implementation, a shelf (40) can be further arranged to accommodate the accommodating structure (10) and the light-emitting diode module (20), wherein the accommodating space (13) can be further provided with a culture (50) (such as wooden meal, rice bran or cereal and the like) so as to supply nutrition required for the growing fungi strains (30). In addition, under the irradiation of light-emitting diode module (20), a better growth environment is created. Certainly, each light-emitting diode in the light-emitting diode module can be a single light source or a hybrid light source and is programmable-controlled by the circuit board. For instance, the illumination time sequence and color of each light-emitting diode can be controlled.

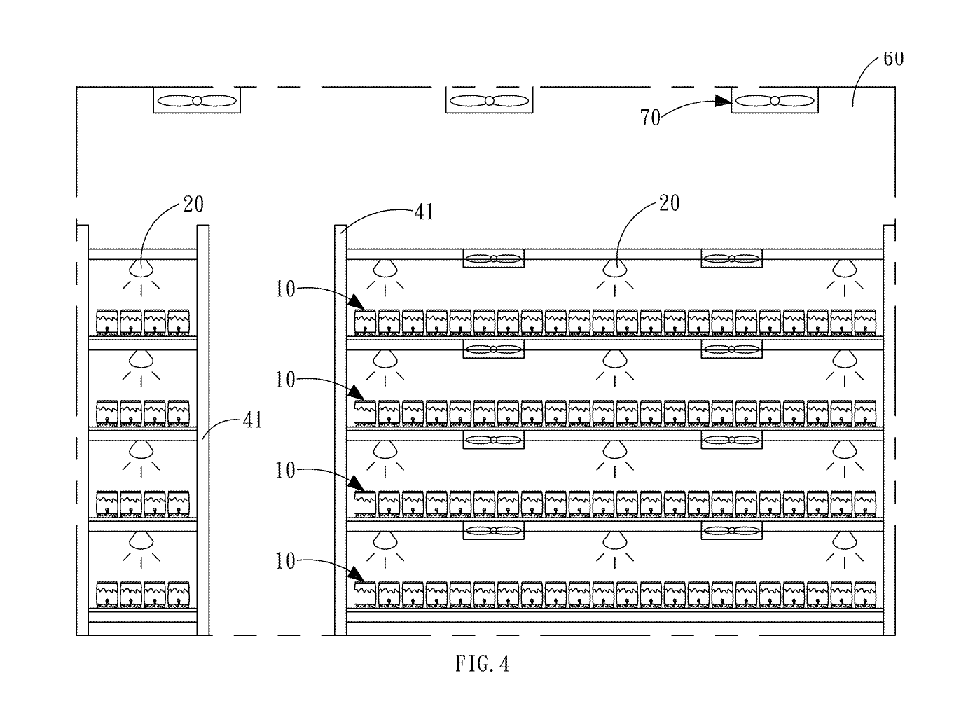

Moreover, the shelf (40) is provided with at least three support tracks (41). The corresponding positions of the support tracks (41) are respectively provided with at least one partition (42). An accommodating tray (43) is arranged on the partition (42) to place a plurality of accommodating structures (10). So that not only it can be produced in mass but also concentrated and managed. In addition, the shelf (40) can be placed in a clean room (60), as shown in FIG. 4. The clean room (60) is provided with a fan filter screen unit (70). The fan filter screen unit (70) is provided with a blower and a filter screen (not shown in the figure), and the filter screen is arranged at an air-outlet below the blower (7) to supply clean air to the inside of the shelf (40), and thus the shelf becoming a dust-free space.

In conclusion, the present invention provides a better feasible fungus cultivation device, which is expected to be presented for the application of the invention according to relative laws; the technical contents and technical characteristics of the present invention have been disclosed as abovementioned, however, those skilled in the art can still perform various substitutions and modifications based on the disclosures of the present invention without departing from the creation spirit of the present invention. Therefore, the protection scope of the present invention is not limited to the disclosures of the embodiments, but includes various substitutions and modifications, which are belonging to the present invention and covered by the applied patent claims as follows.

What is claimed is:

1. A fungus cultivation device, comprising:
an accommodating structure provided with a main body having an opening, wherein the main body is internally provided with an accommodating space to accommodate fungi strains;
a light-emitting diode module provided with a circuit board and a plurality of light-emitting diodes arranged on the circuit board, each light-emitting diode irradiating the accommodating structure.

2. The fungus cultivation device of claim 1, wherein the accommodating space is further provided with a culture.

3. The fungus cultivation device of claim 2, wherein the culture is wooden meal, rice bran or cereal.

4. The fungus cultivation device of claim 1, wherein the accommodating structure is further provided with a light-permeable cover covering the opening to seal the accommodating space.

5. The fungus cultivation device of claim 1, wherein a shelf is further arranged to accommodate the accommodating structure and the light-emitting diode module.

6. The fungus cultivation device of claim 5, wherein the shelf is provided with at least three support tracks, and corresponding positions of the support tracks are respectively provided with at least one partition.

7. The fungus cultivation device of claim 5, wherein the light-emitting diode module is further provided with a power supply member which is connected to the circuit board.

8. The fungus cultivation device of claim 7, wherein the power supply member is a battery or a rechargeable battery.

9. The fungus cultivation device of claim 7, wherein the power supply member is connected to supply mains via an electric wire.

10. The fungus cultivation device of claim 5, wherein the shelf is placed in a clean room which is provided with a fan filter screen unit, and the fan filter screen unit is provided with a blower and a filter screen, and the filter screen is arranged at an air-outlet position below the blower.

11. The fungus cultivation device of claim 1, wherein the main body is a bag.

12. The fungus cultivation device of claim 1, wherein the main body is a bottle.
